(19) United States
(12) Patent Application Publication
(10) Pub. No.: US 2008/0048938 A1
(43) Pub. Date: Feb. 28, 2008

(54) Plasma display panel

(76) Inventors: Hyun Soh, Suwon-si (KR); Se-Jong Kim, Suwon-si (KR); Yun-Hee Kim, Suwon-si (KR); Hyun Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/825,403

(22) Filed: Jul. 5, 2007

(30) Foreign Application Priority Data
Aug. 24, 2006 (KR) 10-2006-0080630

(51) Int. Cl. G09G 3/28

(52) U.S. Cl. 345/60

(57) ABSTRACT

A plasma display panel (PDP) capable of providing excellent luminous efficiency and generating a stable address discharge is provided. The plasma display panel includes a first substrate, a second substrate, a barrier rib, sustain electrode pairs, a first dielectric layer, address electrodes, phosphor layers, and a discharge gas. The second substrate faces the first substrate. The barrier rib is arranged between the first substrate and the second substrate and defines a plurality of discharge cells, sustain electrode pairs arranged on the first substrate, each of the sustain electrode pairs comprising a common electrode and a scan electrode. The first dielectric layer covers the sustain electrode pairs and comprises, in each discharge cell, at least one first groove formed in a portion of the first dielectric layer corresponding to the common electrode and at least one second groove formed in a portion of the first dielectric layer corresponding to the scan electrode. The address electrodes are arranged on the second substrate so as to intersect with the sustain electrode pairs, each of the address electrodes comprising a portion corresponding to the second groove that is wider than the other portions thereof. The phosphor layers are arranged between the first substrate and the second substrate. The discharge gas is inserted between the first substrate and the second substrate.

### CROSS-REFERENCE TO RELATED PATENT APPLICATION

This application claims the benefit of Korean Patent Application No. 10-2006-0080630, filed on Aug. 24, 2006, in the Korean Intellectual Property Office, the disclosure of which is incorporated herein in its entirety by reference.

### BACKGROUND OF THE INVENTION

1. Field of the Invention

The present embodiments relate to a plasma display panel (PDP), and more particularly, to a PDP having an improved luminous efficiency.

2. Description of the Related Art

PDPs, which are being used as a replacement for conventional cathode ray tubes (CRTs), are flat display panels that display desired images by applying a discharge voltage to a discharge gas between two substrates with a plurality of electrodes formed on the substrates to generate ultraviolet (UV) rays, and exciting phosphor layers arranged in a predetermined pattern with the UV rays.

A high discharge voltage is required to drive such conventional PDPs. However, the conventional PDPs still provide low luminous efficiency.

Accordingly, a PDP having a new structure for lowering the discharge voltage of the PDP and increasing luminous efficiency needs to be developed. There remains a demand for a PDP that is driven by a discharge voltage lower than the discharge voltage required to drive conventional PDPs and that provides high luminous efficiency. Moreover, the new PDP needs to generate stable an address discharge although being driven by a low discharge voltage.

### SUMMARY OF THE INVENTION

The present embodiments provide a plasma display panel (PDP) capable of providing excellent luminous efficiency and generating a stable address discharge.

According to an aspect of the present embodiments, there is provided a plasma display panel comprising: a first substrate; a second substrate facing the first substrate; a barrier rib arranged between the first substrate and the second substrate, defining a plurality of discharge cells; sustain electrode pairs arranged on the first substrate, each of the sustain electrode pairs comprising a common electrode and a scan electrode; a first dielectric layer covering the sustain electrode pairs and comprising, in each discharge cell, at lease one first groove formed in a portion of the first dielectric layer corresponding to the common electrode and at least one second groove formed in a portion of the first dielectric layer corresponding to the scan electrode; address electrodes arranged on the second substrate so as to intersect with the sustain electrode pairs, each of the address electrodes comprising a portion corresponding to the second groove that is wider than the other portions thereof; phosphor layers arranged between the first substrate and the second substrate; and a discharge gas inserted between the first substrate and the second substrate.

A distance between the common electrode and the scan electrode of each sustain electrode pair may be greater than a height of the barrier rib structure.

A distance between the first groove and the second groove may be no less than a shortest distance between the common electrode and the scan electrode of a sustain electrode pair and no more than a distance between outside ends of the common electrode and the scan electrode of a sustain electrode pair.

The common electrodes and the scan electrodes may each comprise bus electrodes and transparent electrodes arranged on the bus electrodes.

The transparent electrodes may comprise ITO (indium tin oxide).

At least a portion of each of the first and second grooves may be formed in portions of the first dielectric layer that correspond to the transparent electrodes.

At least a portion of each of the first and second grooves may be formed in portions of the first dielectric layer that correspond to the bus electrodes.

The first dielectric layer may comprise a Bi-based material.

The first dielectric layer may comprise Bi₂O₃.

The first dielectric layer may comprise Bi₂O₃, B₂O₃ and ZnO.

The first grooves and the second grooves may be formed to be discontinuous in the discharge cells.

The first grooves and the second grooves may have substantially rectangular horizontal cross-sections.

A protective layer may be arranged on at least a portion of the first dielectric layer.

The protective layer may comprise magnesium oxide (MgO).

The plasma display panel may further comprise a second dielectric layer to cover the address electrodes.

A portion of each address electrode, which corresponds to the second groove, may have a protruding shape, and the protruding shape may comprise at least a portion of a shape selected from a semi-circle, an oval, and a polygon.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a plasma display panel (PDP) according to an embodiment;

FIG. 2 is a cross-section taken along line II-II of FIG. 1;

FIG. 3 is an arrangement of discharge cells, sustain electrode pairs, address electrodes, first grooves, and second grooves shown in FIG. 2;

FIG. 4 is a picture diagram showing a simulation of the PDP shown in FIG. 1; and

FIG. 5 is a graph showing the result of a simulation performed to determine a transformation efficiency of vacuum UV light of the modeled PDP shown in FIG. 1 while varying a distance between first and second grooves thereof.

### DETAILED DESCRIPTION OF THE INVENTION

The present embodiments will now be described more fully with reference to the accompanying drawings, in which exemplary embodiments are shown.

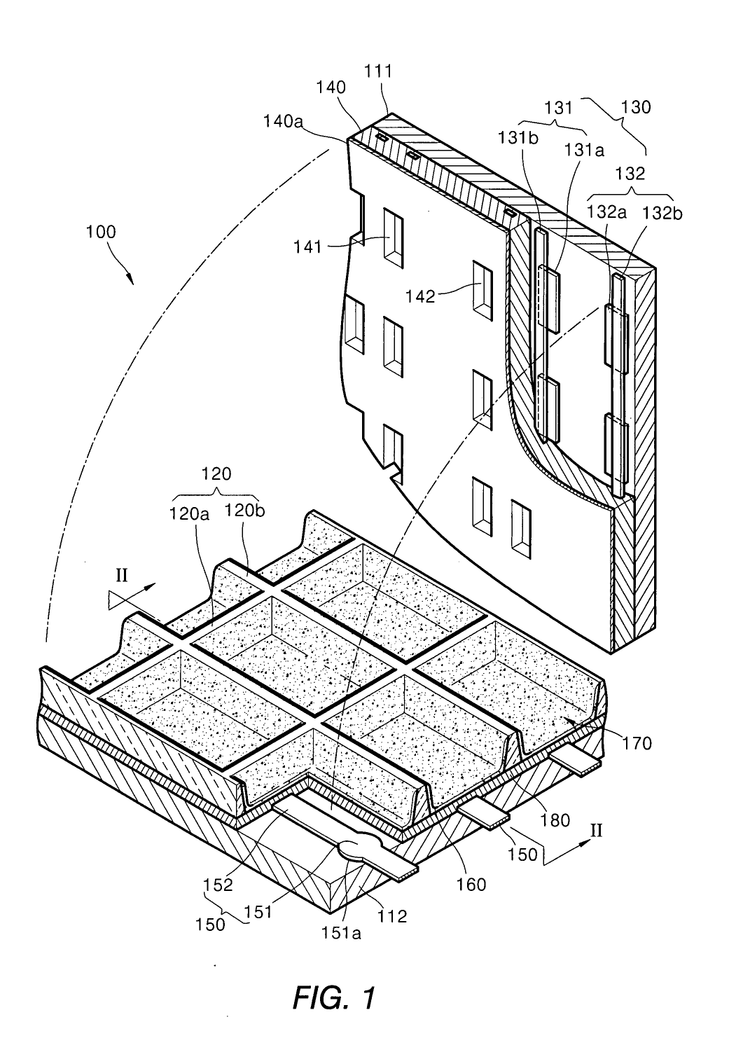

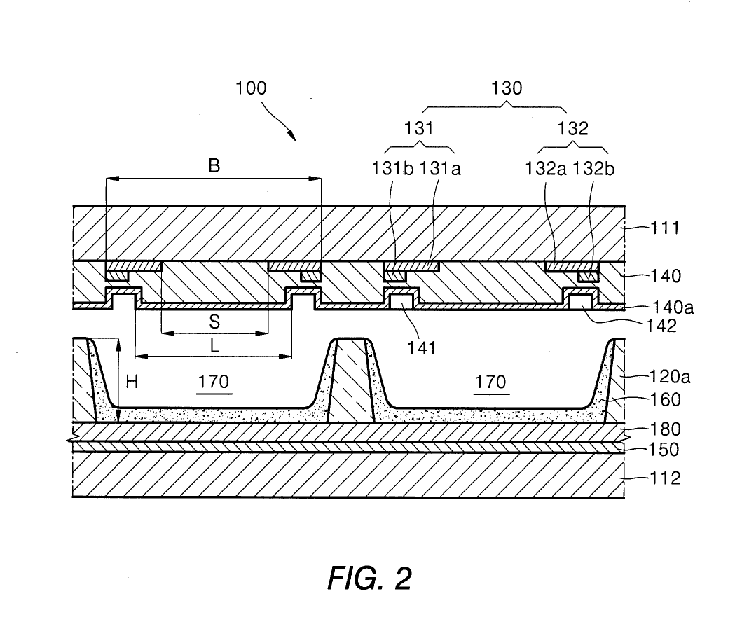

FIG. 1 is an exploded perspective view of a plasma display panel (PDP) 100 according to an embodiment. FIG. 2 is a cross-section taken along line II-II of FIG. 1.

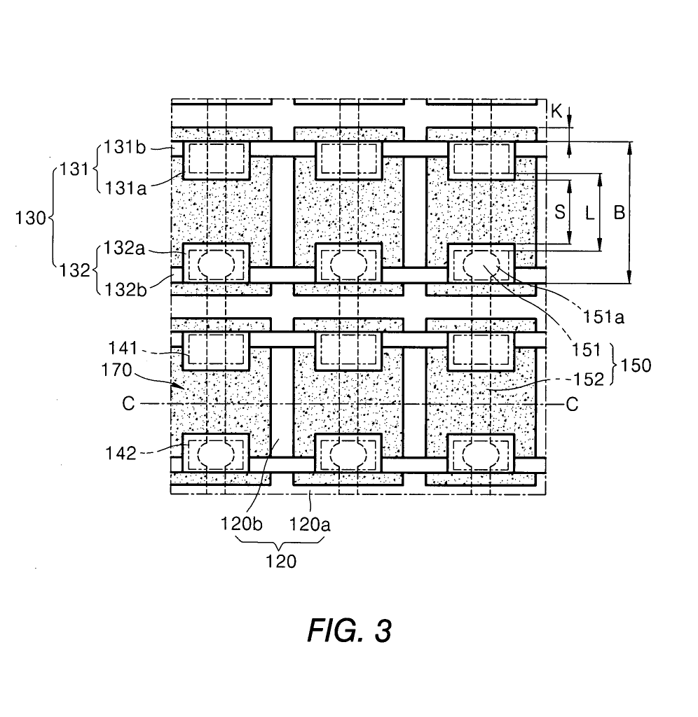

FIG. 3 shows an arrangement of discharge cells 170, sustain electrode pairs 130, address electrodes 150, first grooves 141, and second grooves 142 shown in FIG. 2.

As shown in FIGS. 1 and 2, the PDP 100 includes a first substrate 111, a second substrate 112, a barrier rib structure 120, sustain electrode pairs 130, a first dielectric layer 140, the address electrodes 150, and phosphor layers 160.

The first substrate 111 and the second substrate 112 are spaced apart from each other by a predetermined distance and face each other. The first substrate 111 is formed of transparent glass so as to transmit visible light.

In the present embodiment, the first substrate 111 is transparent, such that visible light generated by a discharge passes through the first substrate 111. However, the present embodiments are not limited to this embodiment. According to the present embodiments, both the first substrate 111 and the second substrate 112 may be transparent. Alternatively, the first substrate 111 and the second substrate 112 may be formed of a semi-transparent material, and colored filters may be installed on the surface of or within the first and second substrates 111 and 112.

The barrier rib 120 is arranged between the first substrate 111 and the second substrate 112, keeps a discharge distance, partitions a discharge space together with the sustain electrode pairs 130 into the discharge cells 170, and prevents electrical and optical cross-talk between discharge cells 170.

The barrier rib 120 includes horizontal barrier ribs 120a and vertical barrier ribs 120b.

In the present embodiment, horizontal cross-sections of the discharge cells 170 defined by the barrier rib 120 are rectangular. However, the present embodiment is not limited to the discharge cells 170 with rectangular horizontal cross-sections. The horizontal cross-sections of the discharge cells 170 may be polygonal (such as triangular or pentagonal), circular, oval, etc. The barrier rib structure 120 may be replaced with strips and thus may have an open structure.

The sustain electrode pairs 130 include common electrodes 131 and scan electrodes 132 and generate a sustain discharge.

The common electrodes 131 and the scan electrodes 132 include transparent electrodes 131a and 132a, respectively, and bus electrodes 131b and 132b, respectively.

In some embodiments, the gap S (see FIG. 2) between the common electrodes 131 and the scan electrodes 132 is greater than a height H of the barrier rib 120. This PDP 100 having a large gap S, which is long, generates a diffusive discharge between the common electrodes 131, the scan electrodes 132, and the address electrodes 140, thereby increasing the luminous efficiency.

In the present embodiment, since the gap S between the common electrodes 131 and the scan electrodes 132 is higher than the height H of the barrier rib structure 120, the PDP 100 has a long gap stricture. However, the present embodiments are not limited to this long gap structure. According to the present embodiments, the gap S between the common electrodes 131 and the scan electrodes 132 may be smaller than the height H of the barrier rib structure.

The transparent electrodes 131a and 132a are arranged in a stripe shape on the bottom surface of the first substrate 111 and include indium tin oxide (ITO), which is a transparent material.

The transparent electrodes 131a and 132a are formed to be discontinuous in the discharge cells 170 and have rectangular shapes. However, the present embodiments are not limited to this arrangement and shape. Also, the transparent electrodes 131a and 132a may each have a stripe shape and extend to be continuous across the discharge cells 170, like the bus electrodes 131b and 132b.

In the present embodiment, the transparent electrodes 131a and 132a include ITO. However, the present embodiments are not limited to this material. The transparent electrodes 131a and 132a may include any material as long as it has high electrical conductivity and is able to transmit visible light.

The bus electrodes 131b and 132b are respectively arranged below the transparent electrodes 131a and 132a. Accordingly, the transparent electrodes 131a are connected to one another and the transparent electrodes 132a are connected to one another.

The bus electrodes 131b and 132b are formed of a highly electrically conductive metal, such as silver (Ag), aluminum (Al), or copper (Cu), and thus have low electrical resistance.

The bus electrodes 131b and 132b may have a single-layered structure, or a multi-layered structure having a white layer and a black layer.

Referring to FIG. 3, the bus electrodes 131b and 132b are spaced a distance K from the horizontal barrier ribs 120a towards the centers of the discharge cells 170.

The first dielectric layer 140 is formed on the first substrate 111 so that the common electrodes 131 and the scan electrodes 132 are buried therein

The first dielectric layer 140 prevents electricity from being directly conducted between the sustain electrode pairs 130 during a sustain discharge and charged particles from colliding with the sustain electrode pairs 130 and damaging the same, and accumulates wall charges by inducing charged particles.

The first dielectric layer 140 can include Bi₂O₃—B₂O₃—ZnO, but the present embodiments are not limited thereto. A first dielectric layer according to the present embodiments may be formed of a PbO—B₂O₃—SiO₂ (lead borosilicate) composite including a Pb-based material. However, it is desirable that the first dielectric layer is formed of a material not including Pb, which is harmful to humans. Thus, the first dielectric layer is preferably formed of a composite including a Bi-based material. Here, the Bi-based material may be Bi₂O₃.

Referring to FIGS. 1 through 3, the first dielectric layer 140 includes first grooves 141 and second grooves 142.

The first grooves 141 and the second grooves 142 are formed to a predetermined depth in the first dielectric layer 140. The depth with which the first grooves 141 and the second grooves 142 are formed depends on the probability of damage of the first dielectric layer 140, an arrangement of wall charges, the value of a discharge voltage, etc.

A first groove 141 and a second groove 142 are formed in each discharge cell 170 and are symmetrical to each other with respect to a virtual line C-C, the same line to which the common electrodes 131 and the scan electrodes 132 are symmetrical to each other.

In the present embodiment, the first grooves 141 and the second grooves 142 have substantially rectangular horizontal cross-sections. However, the present embodiments are not limited to the rectangular horizontal cross-sections. The first grooves 141 and the second grooves 142 may have various shapes of horizontal cross-sections.

The first grooves 141 correspond to parts of the transparent electrodes 131a of the common electrodes 131 and parts of the bus electrodes 131b of the common electrodes 131. The second grooves 142 correspond to parts of the transparent electrodes 132a of the scan electrodes 132 and parts of the bus electrodes 132b. However, the locations of first and second grooves according to the present embodiments are not limited to the locations of the first and second grooves 141 and 142 shown in the present embodiment. The first grooves and the second grooves according to the present embodiments may correspond to only the transparent electrodes 131a and 132a or correspond to only parts of the bus electrodes 131b and 132b.

Due to the presence of the first grooves 141 and the second grooves 142, the thickness of the first dielectric layer 140 is decreased. This leads to an improvement of the rate of forward transmission of visible light. Also, during a subsequent discharge, an electric field is concentrated, and thus a discharge voltage is decreased.

The first grooves 141 and the second grooves 142 may be formed using various methods. For example, the first and second grooves 141 and 142 may be formed by etching or sandblasting.

The first dielectric layer 140 is covered with a protective layer 140a.

The protective layer 140a prevents the first dielectric layer 140 from being damaged due to collision of charged particles and electrons with the first dielectric layer 140 during a discharge. The protective layer 140a also emits many second electrons during the discharge in order to facilitate a plasma discharge. The protective layer 140a has a high secondary electron emission coefficient and is formed of a material having high visible light transmittance, for example, MgO. For example, the protective layer 140a may be formed using a sputtering method.

The address electrodes 150 are arranged on the second substrate 112, and generate an address discharge in cooperation with the scan electrodes 132.

The address electrodes 150 intersect with the sustain electrode pairs 130 and extend across the discharge cells 170. The width of each address electrode 150 is not constant. Parts 151 of each address electrode 150, which face corresponding second grooves 142, are wider than the other parts 152 thereof.

In the present embodiment, when the PDP 100 is viewed vertically, the parts 151 of each address electrode 150, which face the second grooves 142, are not limited to only parts of the address electrode 150 that exist within the outlines of the second grooves 142. Parts of each address electrode 150 including portions beyond the outlines of the second grooves 142 may also be considered as the parts 151 of each address electrode 150 as long as they substantially face the second grooves 142.

In the present embodiment, the parts 151 of the address electrodes 150, which face the second grooves 142, include protrusions 151a, which are semi-circular. The other parts 152 of the address electrodes 150 are stripe-shaped.

In the present embodiment, the protrusions 151a of the address electrodes 150 have semi-circular shapes, and the other parts 152 thereof are stripe-shaped. However, the present embodiments are not limited to these shapes. The shapes of parts of each address electrode that face second grooves are not limited to particular shapes, and the only condition is that the parts of each address electrode that face the second grooves should be wider than the other parts thereof. For example, the shapes of parts of each address electrode that face the second grooves may be oval, or polygonal such as triangular, rectangular, or pentagonal.

The shape of the address electrodes 150 according to the present embodiment improves the stability of an address discharge. In particular, when a small number of wall charges are formed due to the formation of the narrow scan electrodes 132 in order to increase the aperture ratio, the address electrodes 150 having the above-described shape provided a better effect.

In the present embodiment, the address electrodes 150 have protrusions 151a only in the parts 151 that face the second grooves 142, such that excessive increases of a capacitance and current due to an increase of the overall line-width of address electrodes can be prevented. As such, the address electrodes 150 can be prevented from being overheated while operating.

A second dielectric layer 180 is formed on the second substrate 112 and buries the address electrodes 150.

The second dielectric layer 180 is formed of a dielectric material that can prevent the address electrodes 150 from being damaged due to collisions of charged particles or electrons with the address electrodes 150 during a plasma discharge and also can induce charges. The second dielectric layer 180 may be formed of the same dielectric material as that of the first dielectric layer 140.

Phosphors that emit blue, green, and red visible light are coated on portions of the upper surface of the second dielectric layer 180 that correspond to the lower surfaces of the discharge cells 170, and on side surfaces of the barrier rib structure 120, thereby forming phosphor layers 160.

The phosphor layers 160 are classified into blue phosphor layers, green phosphor layers, and red phosphor layers according to the colors of visible light emitted from the phosphor layers 160. Each of the blue phosphor layers 160, the green phosphor layers 160, and the red phosphor layers 160 form lines.

The phosphor layers 160 emit visible light from received UV light. The blue phosphor layers 160 are formed of phosphors such as BaMgAl₁₀O₁₇:Eu, the green phosphor layers 160 are formed of phosphors such as Zn₂SiO₄:Mn, and the red phosphor layers 160 are formed of phosphors such as Y(V,P)O₄:Eu.

The discharge cells 170 are filled with a discharge gas which is a mixture of neon (Ne), xenon (Xe), etc. When the discharge cells 170 are filled with the discharge gas, the first substrate 111 and the second substrate 112 are sealed together by a sealing member, such as frit glass, formed on the edges of the first and second substrates 111 and 112.

Operation of the PDP 100 having this structure will now be described.

The plasma discharge generated in the PDP 100 is roughly divided into an address discharge and a sustain discharge. The address discharge is generated by applying an address discharge voltage to between the address electrodes 150 and the scan electrodes 132, resulting in a selection of discharge cells 170 in which a sustain discharge is to occur.

In the present embodiment, the address electrodes 150 are shaped such that the parts 151 of the address electrodes 150, which face the second grooves 142, are wider than the other parts 152 thereof. Thus, an area on which an address discharge occurs is wide, and accordingly, the wide parts 151 of the address electrodes 150 reinforce an address discharge generated in cooperation with the scan electrodes 132.

Then, a sustain voltage is applied between the common electrodes 131 and the scan electrodes 132 within the selected discharge cells 170, thereby generating a sustain discharge. An electric field concentrates in the first and second grooves 141 and 142 of the first dielectric layer 140. This contributes to a reduction of a discharge voltage, because a discharge path between the common electrodes 131 and the scan electrodes 132 is narrowed by the first grooves 141 and the second grooves 142, an electric field concentrates due to generation of a strong electric field in this narrow discharge path, and the discharge path is densely populated with electric charges, charged particles, etc. This will be described in greater detail later.

As such, UV light is emitted due to drops in the energy level of the discharge gas excited during a sustain discharge. The UV light excites the phosphor layers 160 coated within the discharge cells 170. Consequently, due to drops in the energy level of the excited phosphor layers 160, visible light is emitted and transmitted by the first dielectric layer 140 and the first substrate 111, thereby forming an image that can be recognized by a viewer.

An increase in the luminous efficiency due to the use of the first and second grooves 141 and 142 will now be described in greater detail.

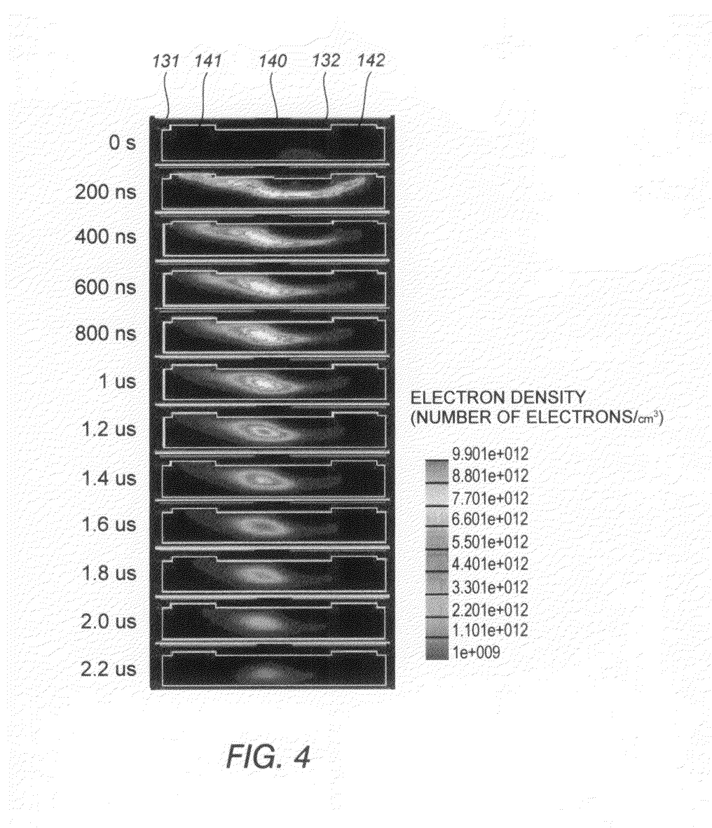

FIG. 4 is a picture diagram showing a simulation of the PDP 100 shown in FIG. 1. FIG. 4 also illustrates the density with which electrons are populated in the discharge cells 170 for a specific period of time during a sustain discharge period. In FIG. 4, a blue color denotes a low electron density, and a red color denotes a high electron density.

Referring to FIG. 4, according to the diffusion of a sustain discharge, the densities of electrons within the first grooves 141 and the second grooves 142 greatly increases. Thus, during the sustain discharge, an electric field concentrates within the first dielectric layer 140 having the first and second grooves 141 and 142 formed therein. Moreover, a discharge toward an efficient, long discharge path is actively generated, so that the luminous efficiency is greatly increased.

The difference between electric potentials of the common electrodes 131 and the scan electrodes 132 in the present embodiment is lower than that between electric potentials of common electrodes and scan electrodes of a conventional PDP because of the first and second grooves 141 and 142. Accordingly, the PDP 100 according to the present embodiment favorably operates in diffusing the sustain discharge to both ends of the common electrodes 131 and the scan electrodes 132. Thus, even when a low sustain voltage is used, the luminous efficiency can be improved by maximizing the discharge path.

The following example simulation results are provided for illustrative purposes only, and are in no way intended to limit the scope of the present embodiments. As a result of a simulation, the transformation efficiency of vacuum UV light of a conventional PDP was 22.77%, whereas the transformation efficiency of vacuum UV light of the PDP 100 according to the present embodiment was 26.47%. Accordingly, the following calculation 26.47−22.77×100/22.77≈16.249 is established, and thus the transformation efficiency of vacuum UV light of the PDP 100 according to the present embodiment is improved at least about 16% compared with the conventional PDP. The transformation efficiency of vacuum UV light is a value obtained by dividing the energy of the vacuum UV light by consumed power, expressed as a percentage.

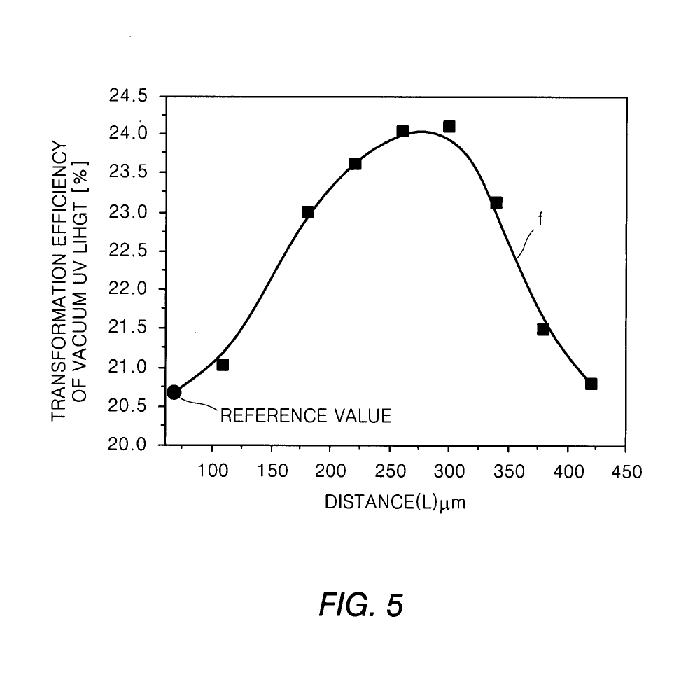

FIG. 5 shows the result of a simulation that was performed on the transformation efficiency of the vacuum UV light of the modeled PDP 100 while varying a distance S between the first and second grooves 141 and 142. In the simulation of FIG. 5, a distance S between the common electrodes 131 and the scan electrodes 132 was set to 110 μm, the widths of the common electrodes 131 and the scan electrodes 132 were set to 155 μm. For comparison, in FIG. 5, the transformation efficiency of the vacuum UV light of a conventional PDP having a first dielectric layer that does not have any grooves is set to be a reference value.

The simulation was made while varying the distance L between the first and second grooves 141 and 142 a total of 8 times from 110 μm to 420 μm, where 110 μm is equal to the smallest gap S between the common electrodes 131 and the scan electrodes 132, and 420 μm is a distance between outside ends of the common electrodes 131 and the scan electrodes 132. The results of the simulation are expressed as rectangular marks. A curve f shown in FIG. 5 represents a result of curve fitting performed on the basis of the results of the simulation.

As a result of the simulation, as the distance L between the first grooves 141 and the second grooves 142 increases, the transformation efficiency of vacuum UV light also increases. The transformation efficiency reaches a maximum when the distance L between the first grooves 141 and the second grooves 142 is about 270 μm to 300 μm, and thereafter decreases. When the distance L between the first grooves 141 and the second grooves 142 is between 110 μm to 420 μm, the transformation efficiency of vacuum UV light of the PDP 100 is greater than that of the conventional PDP.

According to this simulation result, when the distance L between the first and second grooves 141 and 142 is equal to or greater than the gap S between the common electrodes 131 and the scan electrodes 132 and smaller than or equal to the distance B between outside ends of the common electrodes 131 and the scan electrodes 132, the transformation efficiency of the vacuum UV light of the PDP 100 increases. Thus, the PDP 100 provides greatly improved luminous efficiency compared with a conventional PDP.

A PDP according to the present embodiments provides excellent luminous efficiency and generates a stable address discharge.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a first substrate;
a second substrate facing the first substrate;
a barrier rib arranged between the first substrate and the second substrate, defining a plurality of discharge cells;
sustain electrode pairs arranged on the first substrate, wherein each of the sustain electrode pairs comprises a common electrode and a scan electrode;
a first dielectric layer covering the sustain electrode pairs which comprises in each discharge cell, at least one first groove formed in a portion of the first dielectric layer corresponding to the common electrode and at least one second groove formed in a portion of the first dielectric layer corresponding to the scan electrode;
address electrodes arranged on the second substrate so as to intersect with the sustain electrode pairs, wherein each of the address electrodes comprises a portion corresponding to the second groove that is wider than the other portions thereof;
phosphor layers arranged between the first substrate and the second substrate; and
a discharge gas in the discharge cells.

2. The plasma display panel of claim 1, wherein the distance between the common electrode and the scan electrode of each sustain electrode pair is greater than a height of the barrier rib structure.

3. The plasma display panel of claim 1, wherein the distance between the first groove and the second groove is greater than or equal to the shortest distance between the common electrode and the scan electrode of a sustain electrode pair and less than or equal to the distance between outside ends of the common electrode and the scan electrode of a sustain electrode pair.

4. The plasma display panel of claim 1, wherein the common electrodes and the scan electrodes each comprise bus electrodes and transparent electrodes arranged on the bus electrodes.

5. The plasma display panel of claim 4, wherein the transparent electrodes comprise ITO (indium tin oxide).

6. The plasma display panel of claim 4, wherein at least a portion of each of the first and second grooves are formed in portions of the first dielectric layer that correspond to the transparent electrodes.

7. The plasma display panel of claim 4, wherein at least a portion of each of the first and second grooves are formed in portions of the first dielectric layer that correspond to the bus electrodes.

8. The plasma display panel of claim 1, wherein the first dielectric layer comprises a material containing Bi.

9. The plasma display panel of claim 8, wherein the first dielectric layer comprises Bi₂O₃.

10. The plasma display panel of claim 9, wherein the first dielectric layer comprises at least one of Bi₂O₃, B₂O₃ and ZnO.

11. The plasma display panel of claim 1, wherein the first grooves and the second grooves are formed to be discontinuous in the discharge cells.

12. The plasma display panel of claim 11, wherein the first grooves and the second grooves have substantially rectangular horizontal cross-sections.

13. The plasma display panel of claim 1, wherein a protective layer is arranged on at least a portion of the first dielectric layer.

14. The plasma display panel of claim 13, wherein the protective layer comprises magnesium oxide (MgO).

15. The plasma display panel of claim 1, further comprising a second dielectric layer configured to cover the address electrodes.

16. The plasma display panel of claim 1, wherein a portion of each address electrode, which corresponds to the second groove, has a protruding shape.

17. The plasma display panel of claim 16, wherein the protruding shape comprises at least a portion of a shape selected from a semi-circle, an oval, and a polygon.
